(19) United States
(12) Patent Application Publication
(10) Pub. No.: US 2011/0026457 A1
(43) Pub. Date: Feb. 3, 2011

(54) SYSTEM FOR USING INTERNET TELEPHONE WITH MOBILE AND METHOD THEREOF

(76) Inventor: Hyukhoon Shim, Incheon (KR)

Correspondence Address: LEXYOUME IP GROUP, PLLC, 5180 PARKSTONE DRIVE, SUITE 175, CHANTILLY, VA, 20151, US

(21) Appl. No.: 12/733,195

(22) PCT Filed: Aug. 7, 2008
(86) PCT No.: PCT/KR2008/004593

§ 371 Date: Jun. 1, 2010

(30) Foreign Application Priority Data
Aug. 7, 2007 (KR) 10-2007-0078805

(51) Int. Cl. H04L 12/66; H04W 4/12; H04W 12/06

(52) U.S. Cl. 370/328; 370/352; 455/411; 455/466

(57) ABSTRACT

This invention relates to VoEP phone that send-receive voice through the internet and normal phone that send-receive voice using PSTN (Public Switched Telephone Network) that is a telephone system that do send-receive be, and more particularly not exclusively, the invention relates to a system and method that use VoP phone and normal phone using mobile communication terminal. According to the present invention that is proposed in order to achieve purpose such as preceding, a system that use VoP phone and normal phone using mobile communication terminal comprises VoIP phone or normal phone; mobile communication terminal that can connect to wireless internet; WAP (Wireless Application Protocol) server that send mobile communication terminal telephone number and destination telephone number of linked user inputted to preceding mobile communication terminal to service application server; service application server that is linked with preceding WAP server, and includes VoP phone user or database that store normal telephone user information and mobile communication terminal information linked with preceding VoP phone or normal phone, and set up user authentication and call service model; gateway that is connected with preceding service application server, does user authentication and request call to mobile communication terminal of linked user and destination terminal.

### TECHNICAL FIELD

This invention relates to VoIP phone that send-receive voice through the internet and normal phone that send-receive voice using PSTN (Public Switched Telephone Network), and more particularly not exclusively, the invention relates to a system and method that use VoIP phone and normal phone using mobile communication terminal.

### BACKGROUND ART

Usually, as is illustrated to [FIG. 1], unlike normal phone that impose gradation fare by distance in PSTN (Public Switched Telephone Network), VoIP phone fare of internet inside section be free of charge, and amounts to expense in PSTN between only received telephone in linked received telephone office to internet. Therefore, because communication fee is inexpensive, it is trend that usage of VoIP phone is increasing rapidly at general home or office.

However, usual VoIP phone and normal phone are following problem.

Because normal phone is a telephone that is established in PSTN, linked user in near distance can use several telephone by a telephone circuit, and can not use in any other space.

Also, because VoIP phone is possible use in place that VoIP phone terminal was linked to internet line by wire, or can connect to wireless LAN of AP (Access Point) device surrounding, there is spatial restriction.

Therefore, in spite of that was joined to VoIP phone or normal phone, user can not but use mobile communication terminal of cellular phone etc. in case of there is VoIP phone or normal phone in placed place and other place, and the expense is also cost.

Also, there is problem that can not use main telephone number of company in case of member who outside duty or official trip is frequent in company or organization that several members use sharing VoIP phone and normal phone calls to cooperation enterprise or company member.

### DISCLOSURE OF INVENTION

### Technical Problem

This invention is to be proposed to solve usual problem such as preceding descriptions,

First, present invention stores VoIP phone or normal phone subscriber mobile communication terminal telephone number to service application server's database, do by purpose that several members use one Internet telephone number or general telephone number.

Second, when there is in place unconnecting to place, place unconnecting to internet line, wireless LAN unconnecting to normal phone, present invention does to use VoIP phone or normal phone by action that transmit linked user number and destination terminal telephone number on service application server and gateway in mobile communication terminal through connecting wireless internet or sending SMS, do by purpose that remove in spatial restriction of VoIP phone or normal phone.

Third, several linked users of VoIP phone subscriber do VoIP phone or normal phone so that is available in mobile communication terminal, do by purpose that reduce call expense of mobile communication terminal.

Fourth, even if use many mobile communication terminal, do by purpose that can call by registered main VoIP phone number or general telephone number.

Fifth, establishing call service model to service application server according to user's convenience, do by purpose that do so that can do accounting selecting in VoIP phone, normal phone or linked user mobile communication terminal, and establish caller identification display.

### Technical Solution

To achieve purpose such as preceding descriptions, VoIP phone and normal phone use system that use mobile terminal by proposed this invention

VoIP phone or normal phone; mobile communication terminal that can connect to wireless internet; WAP server (Wireless Application Protocol Server) that send mobile communication terminal telephone number and destination telephone number of linked user inputted to preceding mobile communication terminal to service application server; service application server that is linked with preceding WAP server, and includes VoIP phone user or database that store normal telephone user information and mobile communication terminal information linked with preceding VoIP phone or normal phone, and set up user authentication and call service model; gateway that is linked with preceding service application server, and is user authentication and do by characteristic that is consisted of gateway that do call request to send mobile communication terminal of linked user and destination terminal.

Also, VoIP phone and normal phone use system that use mobile terminal by this invention,

VoIP phone or normal phone; mobile communication terminal that is available to send SMS; SMS server (Short Message Service Server) that send VoIP phone number or normal phone number and mobile communication terminal telephone number of linked user and destination telephone number inputted message on preceding mobile communication terminal to service application server; include database that store mobile communication terminal information that is linked with preceding SMS server, and worms with VoIP phone user or normal phone user information and preceding VoIP phone and normal phone, and is user authentication and call service model; gateway that is linked with preceding service application server, and is user authentication and do by characteristic that is consisted of gateway that do call request to send mobile communication terminal of linked user and destination terminal.

To achieve purpose such as preceding descriptions, VoIP phone and normal phone use method that use mobile terminal by proposed this invention

a) Step that register information of VoIP phone or normal phone on gateway;

b) Step that store linked user's mobile terminal information of VoIP phone or normal phone to service application server;

c) Step connecting to wireless internet using mobile communication terminal;

d) Step that authenticate linked user on service application server;

e) Step that inputs destination telephone number in mobile communication terminal and sends to service application server;

f) Step that connect call to linked user through gateway;

g) Step that request call by destination terminal through gateway;

h) Step that charge after call and call completion with linked user and destination person through service application server; that include by characteristic do.

Also, VoIP phone and normal phone use method that use mobile communication terminal by present invention are marked by that include below phase,

a) Step that register information of VoIP phone or normal phone on gateway;

b) Step that store linked user's mobile terminal information of VoIP phone or normal phone to service application server;

c) Step that inputs VoIP phone number or normal phone number and destination telephone number to SMS in mobile communication terminal, and sends to service application server;

d) Step that authenticate linked user through service application server;

e) Step that connect call to linked user through gateway;

f) Step that request call by destination terminal through gateway;

g) Step that do accounting after call and call completion with linked user and destination person through service application server;

### Advantageous Effects

As explain above, VoIP phone and normal phone use system and the method that use mobile terminal by this invention

First, storing mobile communication terminal number of VoIP phone subscriber or normal phone subscriber linked user to service application server's database, there is effect that several members can use one VoIP phone or normal phone.

Second, using mobile communication terminal in place, place that internet line is not connected, that normal phone is not placed and that wireless LAN is not connected, VoIP phone or normal phone use does so that VoIP phone or normal phone use may be possible, VoIP phone or normal phone use removes spatial restriction of VoIP phone by method that send telephone number of linked user and telephone number of destination terminal to internet exchange server by connecting to wireless internet or sending SMS, there is effect that VoIP phone or normal phone use during transfer is possible in outskirts of a city or foreign countries.

Third, because several linked users of VoIP phone or normal phone can use VoIP phone or normal phone in mobile communication terminal, there is effect that can reduce call expense of mobile communication terminal.

Fourth, even if use many mobile communication terminal, there is effect that can call on registered main VoIP phone number or normal phone number.

Fifth, setting call service model to service application server according to user's convenience, there is effect that can charge by choosing VoIP phone or normal phone or linked user's mobile communication terminal.

Sixth, there is advantage that can use VoIP phone in mobile communication terminal without special software.

Seventh, there is effect that user who is not joined to VoIP phone or wire telephony can use VoIP phone or normal phone in mobile communication terminal through service provider.

### BRIEF DESCRIPTION OF THE DRAWINGS

FIG. 1 is a structure diagram illustrating an embodiment of normal phone system or VoIP phone system.

FIG. 2 is a structure diagram illustrating a system of using VoIP phone or normal phone on mobile communication terminal according to at least one aspect of the present invention.

FIG. 3 is the first example of mobile terminal LCD illustrating a system of using VoIP phone or normal phone on mobile communication terminal according to one aspect of the present invention.

FIG. 4 is the second example of mobile terminal LCD illustrating a system of using VoIP phone or normal phone on mobile communication terminal according to one aspect of the present invention.

FIG. 5 is the third example of mobile terminal LCD illustrating a system of using VoIP phone or normal phone on mobile communication terminal according to one aspect of the present invention.

FIG. 6 is a flow diagram of the first example illustrating a system of using VoIP phone or normal phone on mobile communication terminal according to one aspect of the present invention.

FIG. 7 is a structure diagram of the second example illustrating a system of using VoIP phone or normal phone on mobile communication terminal according to one aspect of the present invention.

FIG. 8 is a flow diagram of the second example illustrating a system of using VoIP phone or normal phone on mobile communication terminal according to one aspect of the present invention.

FIG. 9 is the forth example of mobile terminal LCD illustrating a system of using VoIP phone or normal phone on mobile communication terminal according to one aspect of the present invention.

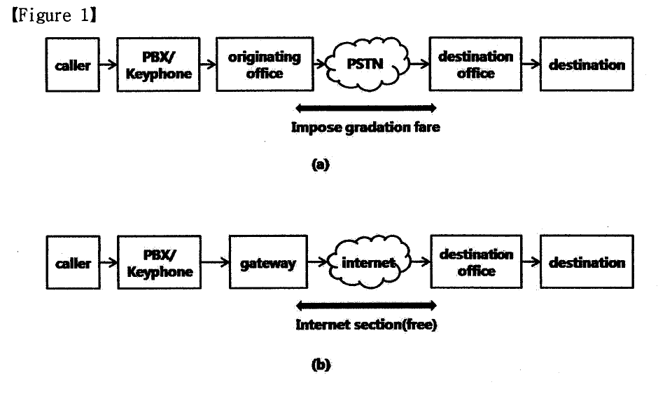

### SIMPLE REPRESENTATION OF SYMBOLS FOR MAIN PART OF DRAWING

100: Calling mobile communication terminal

110: WAP server

120: Service application server

130: Gateway

140: Database

150: VoIP phone

160: SMS server

200: destination terminal

### MODE FOR THE INVENTION

To achieve purpose such as preceding, first enforcement example of VoIP phone and normal phone use system that use mobile communication terminal by proposed present invention is consisted of VoIP phone, calling mobile communication terminal, WAP server, service application server, gateway and destination terminal.

Preceding VoIP phone is available replace by normal phone.

In below, explain in detail desirable enforcement instance of present invention that refer affixing drawing.

[FIG. 2] is a structure diagram illustrating a system of using VoIP phone or normal phone on mobile communication terminal according to at least one aspect of the present invention.

As is illustrated to [FIG. 2], in preceding mobile communication terminal (100) there is cellular phone, individual portable information terminal (PDA), Wibro terminal, portable multimedia player (PMP) and electronic dictionary, and should be possible to connect to wireless internet.

Preceding mobile communication terminal (100) used cellular phone and portable Information-Communication terminal (PDA) that have function of mobile telephone in enforcement example by present invention.

In case of use portable multimedia player (PMP) or electronic dictionary which mobile telephone function does not exist, as well as destination terminal telephone number, must input together mobile communication terminal telephone number of linked user.

Preceding WAP (Wireless Application Protocol) server (110) is wireless application protocol, and send VoIP phone number (or normal phone number), linked user's mobile communication terminal telephone number and destination telephone number inputted according to request of preceding mobile communication terminal to service application server (120).

Preceding service application server (120) is connected with preceding WAP server (110), and includes database (140) that store information of VoIP phone user (or normal phone user) and information of mobile communication terminal (100) linked with preceding VoIP phone, and sets user authentication and call service model.

Preceding database (140) stores information of VoIP phone or normal phone as well as information of mobile communication terminal linked with VoIP phone or normal phone.

Also, preceding service application server (120) confirms whether information of mobile communication terminal that transfers from WAP server (110) was stored by linked user to database (140), and in case of user was registered by linked user send information of mobile communication terminal to gateway (130), otherwise send registration request message to mobile communication terminal.

In addition, preceding service application server (120) can charge fare of VoIP phone (or normal phone) selecting VoIP phone or mobile communication terminal according to user's convenience, and can select caller identification display.

For example, calls by main telephone number of company, or calls by company's a name, office's name or user's name separating linked user's mobile communication terminal by group.

That is, using mobile communication terminal (100) in outside, because user call with main telephone number, can raise usage of main telephone number, and probability is low to be recognized by spam call.

Of course, if there are a lot of linked users, VoIP phone is more profitable in chargeable side than normal phone.

Preceding gateway (130) is connected with preceding service application server (120), is user authentication and do call request to mobile communication terminal of linked user and destination terminal.

Also, gateway (130) is registered information of VoIP phone or normal phone, and is included server information including preceding service application server's IP address.

In addition, gateway (130) can use general gateway, but it is desirable that use open service gateway.

Because, general gateway (130) is restriction about common carrier, each common carrier managed information connection, call connection, but third party service provider can connect communication resource of open service gateway through service application server (120) opening function of communications network.

At present open service interface (Open API) technology is enacting through Parlay group, and this is announced with 3GPP members who is standard organization actually of 3 generation mobile communication by standard of 3GPPs, ETSI, 3GPP2 etc. through JWG (Joint Working Group) activity.

TPC (Third Party Call) interface that is one of this open service interface (Open API) enables access about call connection function of land network or mobile network in open service gateway.

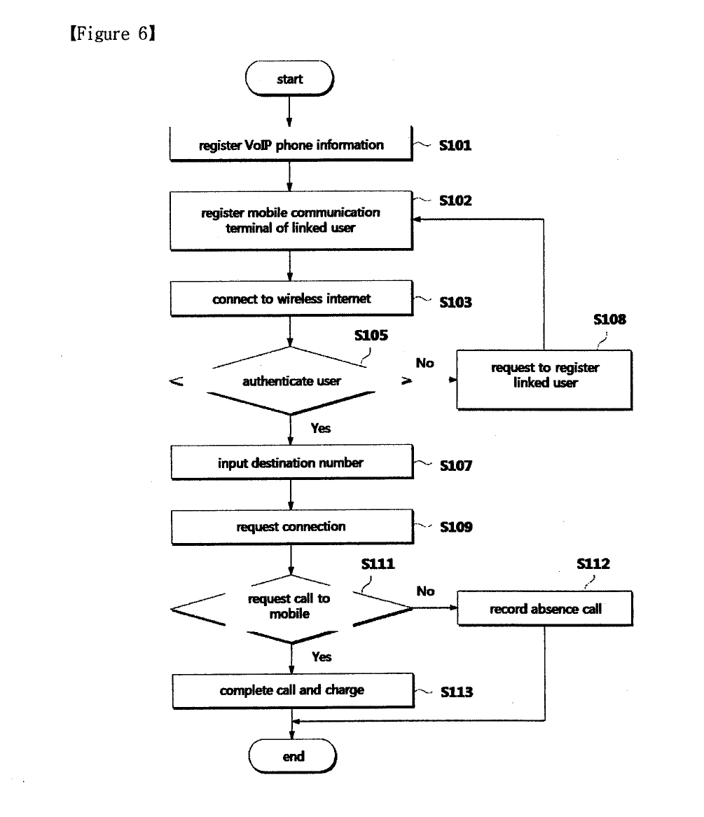

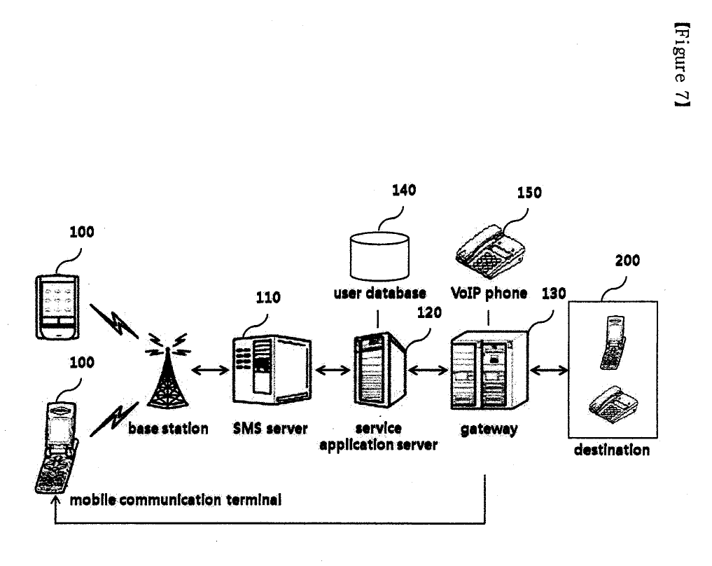

As first enforcement example of the method that use VoIP phone and normal phone using mobile terminal according to present invention register information of VoIP phone or normal phone and information of service application server (120) on gateway (130) like [FIG. 6]. (S101)

Next, accomplish step that store mobile communication terminal information of linked user of VoIP phone (150) to service application server (120). (S102)

Preceding S101 step and S102 step can accomplish at the same time, or S102 accomplish first.

Next, accomplish step connecting to wireless internet using mobile communication terminal(100). (S103)

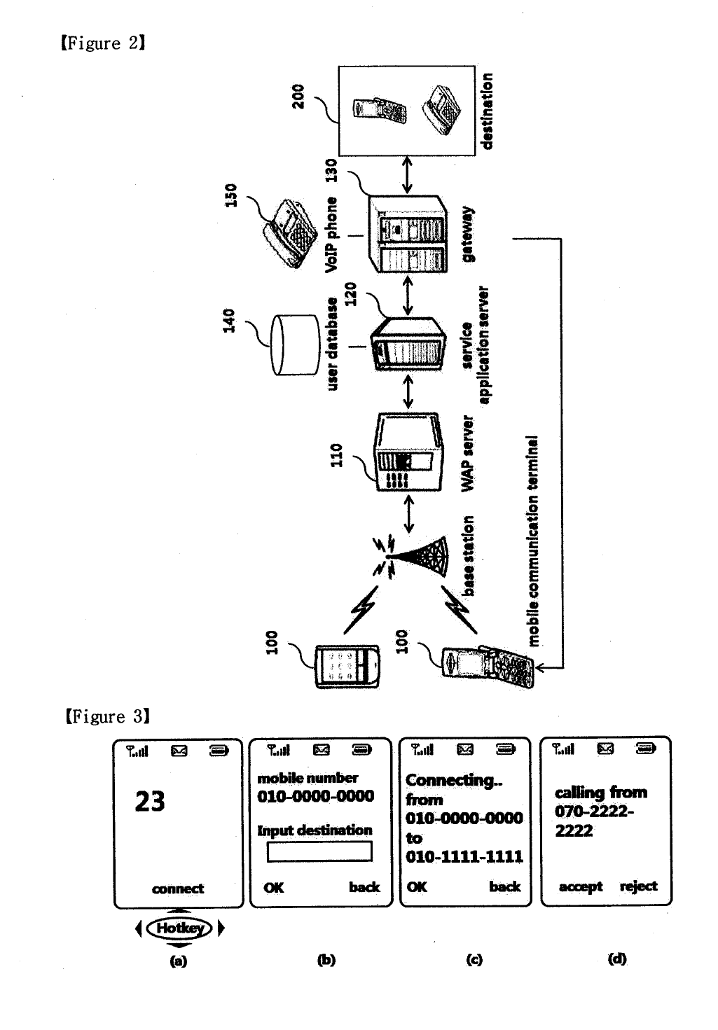

(a) of [FIG. 3] is a drawing that display LCD of mobile communication terminal (100) of preceding S103 step in enforcement example of present invention.

Number ‘23’ that is illustrated to drawing is wireless internet address of service provider that support the system using VoIP phone and normal phone on mobile communication terminal according to present invention.

At preceding S103 step, through WAP server (110), mobile communication terminal information transfers by service application server (120).

Next, through service application server (120), accomplish step that authenticate linked user. (S105)

Mobile communication terminal information that transfer from WAP server (110) at preceding S105 step confirms whether agree with information that is stored to database (140).

Next, if succeed in linked user authentication, accomplish step sent to service application server (120) after input destination telephone number in mobile communication terminal (100). (S107)

(b) of [FIG. 3] is a drawing that display LCD of preceding mobile communication terminal (100) at preceding S107 step, and window that input telephone number of destination terminal (200) by page offering in service application server (120) was created.

If input telephone number of destination terminal (200), is marked on LCD with (c) of [FIG. 3].

If fail in linked user authentication, accomplish step that send to linked user registration request message to mobile communication terminal (100). (S108)

Next, through gateway (130), accomplish step that call connection to mobile communication terminal of linked user. (S109)

(d) of [FIG. 3] is a drawing that display LCD of mobile communication terminal (100) at preceding S109 step according to present invention.

Next, if is connected with mobile communication terminal (100) of linked user, through gateway (130), accomplish step that call request by destination terminal (200). (S111)

At the same time, preceding S109 step and S111 step is possible achievement. That is, can accomplish step that request call to mobile communication terminal (100) and destination terminal (200) at the same time.

However, if destination terminal (200) becomes priority call connection than mobile communication terminal (100), because destination person's call waiting time is prolonged, destination terminal (200) is desirable sequential progress that call is linked after mobile communication terminal (100) becomes priority call connection.

And at preceding S111 step, did call request to destination terminal (200), but there is occasion that fail for busy or from absence in call connection or occasion that have dropped on his own initiative call connection in mobile communication terminal (100) among call request to destination terminal (200).

This time, if there is caller identification display (CID) function to destination terminal (200), to destination terminal (200) according to call service model that is established to service application server (120) telephone number of mobile communication terminal (100) or telephone number of VoIP phone (150) in absence received call record remain, and accomplish step that end. (S112)

Next, if is connected call with destination terminal (200), between linked user and destination person call is achieved, and accomplishes charging step after call completion. (S113)

Method that input telephone number of destination terminal (200) of preceding S107 step in first enforcement example of VoIP phone and normal phone use method that use mobile communication terminal according to present invention, can input telephone number like (b) of [FIG. 3] directly, or input searching telephone number that is stored to service application server (120)'s database (140), and input is possible by various method.

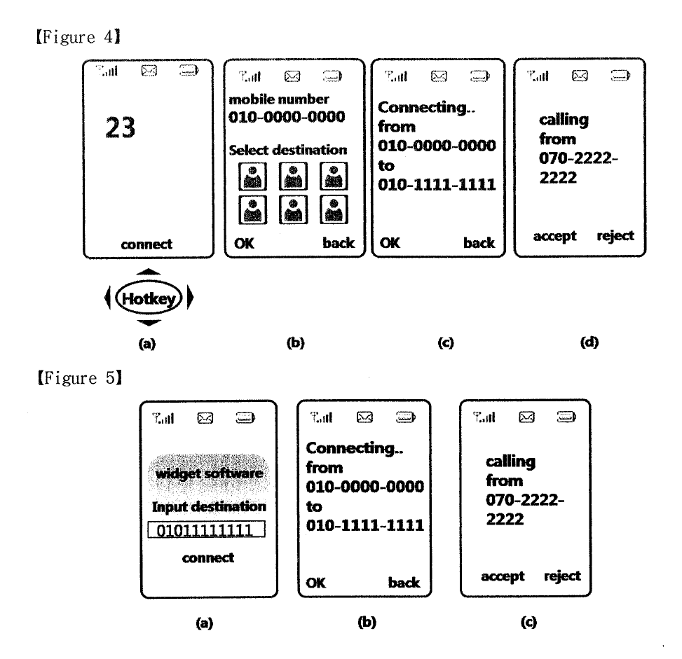

As is illustrated to [FIG. 4] by the second example, can input telephone number of destination terminal (200) using picture, image or avatar etc. stored to database (140).

As is illustrated to [FIG. 5] by the third example, install widjet software on main display of mobile communication terminal (100), can input destination terminal (200) telephone number.

If use widjet software, without process that inputs preceding wireless internet connection address and connects, can connect call through set of software.

The preceding third example can use usefully when mobile communication terminal (100) is no telephone function or SMS function (ex. PMP, electronic dictionary etc.).

In case of use mobile communication terminal that this telephone or SMS function does not exist, it is desirable that store all identification information of mobile communication terminals that linked user to service application server (120)'s database (140) at preceding S102 step.

That is, by linked user stores identification information of all available mobile communication terminals, multiple device registration is available without regard to specification mobile communication terminal, and user authentication process can be achieved rapidly.

[FIG. 7] is a structure diagram of the second enforcement example illustration a system of using VoIP phone or normal phone on mobile communication terminal according to present invention.

As is illustrated to [FIG. 7], second enforcement example that use VoIP phone on mobile communication terminal according to present invention is consisted of VoIP phone (150), mobile communication terminal (100), SMS server (160), service application server (120), gateway (130) and destination terminal (200).

Also, VoIP phone (150) of the preceding second enforcement example with the first enforcement example equally is available replace by normal phone.

Difference is that SMS server (160) is included instead of WAP server (110) with first enforcement example by present invention.

Preceding SMS server (160) send contents of short message received from mobile communication terminal (100) to preceding service application server (120).

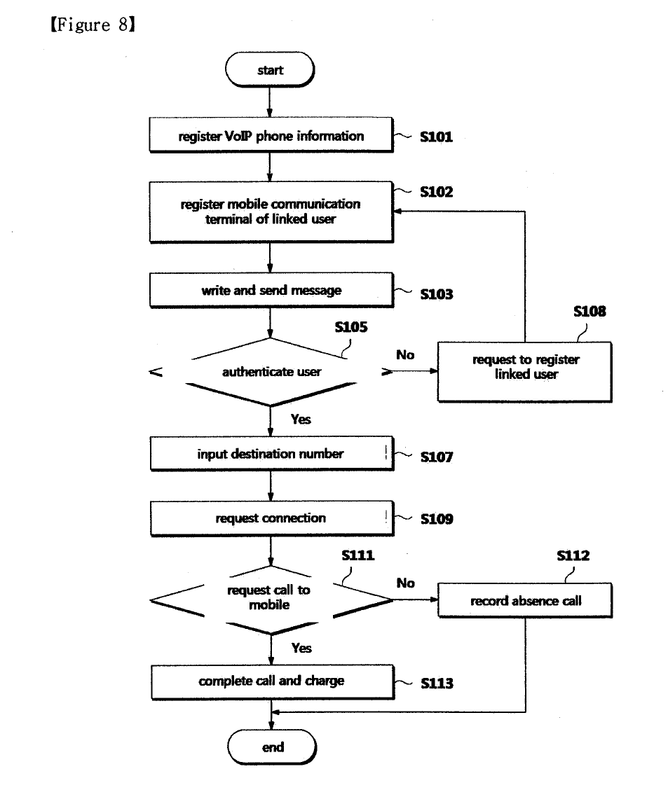

Therefore, there is effect that can use VoIP phone through sending SMS in case of is difficult of connecting wireless internet in mobile communication terminal (100).

[FIG. 8] is a flow diagram of the second example illustrating a system of using VoIP phone or normal phone on mobile communication terminal according to one aspect of the present invention.

As is illustrated to [FIG. 8], register information of VoIP phone and information of service application server (120) on gateway (130). (S201)

Accomplish step that store mobile communication terminal information of linked user of VoIP phone (150) to service application server (120). (S202)

Preceding S201 step and S202 step can accomplish at the same time achieve and accomplish first S102 step.

Next, accomplish step that make SMS using mobile communication terminal (100). (S203)

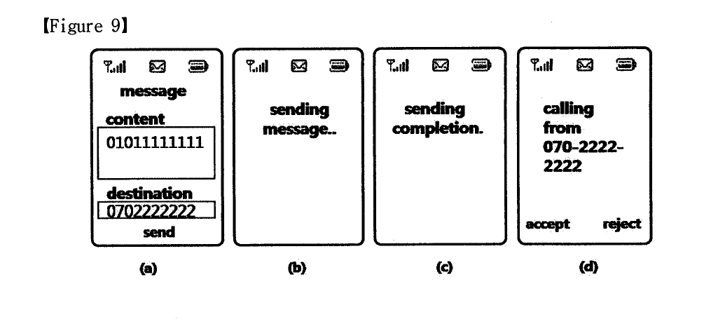

(a) of [FIG. 9] is a drawing that display LCD of mobile communication terminal (100) of preceding S203 step in second enforcement example of present invention.

At preceding S203 step, send information of destination terminal and information of mobile communication terminal to service application server (120) through SMS server (160).

Also, the contents of SMS is consist of service provider number, destination terminal telephone number or mobile communication terminal number.

Preceding service provider means company which provide VoIP service using mobile communication terminal.

(b) and (c) of [FIG. 9] are a drawing that written message transfers to service application server (12) in LCD of mobile communication terminal (100).

Next, through service application server (120), accomplish step that authenticate linked user. (S205)

At preceding S205 step, confirm information whether information received from SMS server (160) agree that is stored to database (140).

If fail in linked user authentication, accomplish step that request registration message to mobile communication terminal (100). (S207)

Next, through gateway (130), accomplish step that call connection to mobile communication terminal of linked user. (S209)

(d) of [FIG. 9] is a drawing that display LCD of mobile communication terminal (100) at preceding S209 step according to present invention.

Next, if is connected with mobile communication terminal (100) of linked user, through gateway (130), accomplish step that call request to destination terminal (200). (S211)

At the same time, preceding S209 step and S211 step is possible achievement. That is, can accomplish step that request call to mobile communication terminal (100) and destination terminal (200) at the same time.

However, if destination terminal (200) becomes priority call connection than mobile communication terminal (100), because destination person's call waiting time is prolonged, destination terminal (200) is desirable sequential progress that call is connected after connecting mobile communication terminal (100) call.

And at preceding S211 step, did call request to destination terminal (200), but there is occasion that fail for busy or from absence in call connection or occasion that have dropped on his own initiative call connection in mobile communication terminal (100) among call request to destination terminal (200).

This time, if there is caller identification display (CID) function to destination terminal (200), to destination terminal (200) according to call service model that is established to service application server (120) telephone number of mobile communication terminal (100) or telephone number of VoIP phone (150) in absence call number record remain, and achieves stage that end. (S212)

Next, if become destination terminal (200) and call connection, between linked user and destination person call is established, and accomplishes step charging after call completion. (S213)

Storing information of mobile communication terminal of VoIP phone subscriber's linked to service application server (120)'s database (140) if embody VoIP phone use system and method that use mobile communication terminal according to present invention, because several member can use one Internet telephone number, there is cost-cutting effect.

Also, because service provider can offer VoIP phone or normal phone directly and set charging form variously, mobile communication terminal user who does not have VoIP phone or normal phone can use the service that use VoIP phone or normal phone on mobile communication terminal by subscribing service.

That is, there is effect that can lower communication fare of mobile communication terminal into VoIP phone or normal phone fare.

As mentioned above, explained enforcement instance of present invention but can embody by the system and method that use VoIP phone on various mobile communication terminal in category that technological thought of present invention does not escape technological thought of present invention and is not limited to the preceding enforcement example.

1. A system for utilizing an Internet telephone and a typical telephone using a mobile communication terminal, comprising:
an Internet telephone or a typical telephone;
at least one mobile communication terminal enabling use of wireless Internet;
a Wireless Access Protocol (WAP) server for transmitting a phone number of the mobile communication terminal of a linked user and a phone number of a called terminal, which are input to the mobile communication terminal, to a service application server;
the service application server connected to the WAP server, and provided with a database for storing information about Internet telephone users or typical telephone users and information about mobile communication terminals linked to the Internet telephone or the typical telephone, the service application server performing a user authentication operation and a call service type setting operation; and
a gateway connected to the service application server and configured to request connection of a call from the mobile communication terminal of the linked user and the called terminal after the authentication of the user has been completed.

2. The system according to claim 1, wherein the transmission of the phone number of the mobile communication terminal of the linked user and the phone number of the called terminal to the service application server is performed by selecting a phone number, a picture or an image stored in the database or by entering a phone number using an idle screen program of the mobile communication terminal.

3. A system for utilizing an Internet telephone and a typical telephone using a mobile communication terminal, comprising:
an Internet telephone or a typical telephone;
at least one mobile communication terminal enabling sending of a text message;
a Short Message Service (SMS) Server for transmitting a phone number of the mobile communication terminal of a linked user, a phone number of a called terminal, and a number of a service provider, which are input by the text message of the mobile communication terminal, to a service application server;
the service application server connected to the SMS server, and provided with a database for storing information about Internet telephone users or typical telephone users and information about mobile communication terminals linked to the Internet telephone or the typical telephone, the service application server performing a user authentication operation and a call service type setting operation; and
a gateway connected to the service application server and configured to request connection of a call from the mobile communication terminal of the linked user and the called terminal after the authentication of the user has been completed.

4. The system according to claim 1, wherein the mobile communication terminal comprises a mobile phone, a Personal Digital Assistant (PDA), a Wibro terminal, a Personal Multimedia Player (PMP) or an electronic dictionary.

5. The system according to claim 4, wherein the call service type set in the service application server comprises setting of charges for calls or setting of display of caller Identification (ID).

6. A method of utilizing an Internet telephone and a typical telephone using a mobile communication terminal, comprising the steps of:
a) registering information about an Internet telephone or a typical telephone in a gateway;
b) storing information about a mobile communication terminal of a user, linked to the Internet telephone or the typical telephone, in a service application server;
c) accessing wireless Internet using the mobile communication terminal;
d) performing an operation of authenticating the linked user through the service application server;
e) entering a phone number of a called terminal using the mobile communication terminal, and then transmitting the phone number of the called terminal to the service application server;
f) connecting a call to the linked user via a gateway;
g) requesting connection of the call from the called terminal via the gateway; and
h) conducting conversation between the linked user and a called party through the service application server, and then charging a corresponding communication fee for the call after the conversation has been terminated.

7. The method according to claim 6, wherein a method of transmitting a phone number of the mobile communication terminal of the linked user and the phone number of the called terminal to the service application server comprises a method of selecting a phone number, a picture or an image stored in a database or a method of entering a phone number using an idle screen program.

8. A method of utilizing an Internet telephone and a typical telephone using a mobile communication terminal, comprising the steps of:
a) registering information about an Internet telephone or a typical telephone in a gateway;
b) storing information about a mobile communication terminal of a user, linked to the Internet telephone or the typical telephone, in a service application server;
c) creating a text message using the mobile communication terminal so that a phone number of the Internet telephone, a phone number of a called terminal, and a number of a service provider are included in the text message, and sending the text message to a service application server;
d) performing an operation of authenticating the linked user through the service application server;
e) connecting a call to the linked user via a gateway;
f) requesting connection of the call from the called terminal via the gateway; and
g) conducting conversation between the linked user and a called party through the service application server, and then charging a corresponding communication fee for the call after the conversation has been terminated.

9. The method according to claim 6, wherein the mobile communication terminal comprises a mobile phone, a Personal Digital Assistant (PDA), a Wibro terminal, a Personal Multimedia Player (PMP) or an electronic dictionary.

10. The method according to claim 6, wherein the step of conducting conversation between the linked user and the called party through the service application server and then charging the corresponding communication fee for the call after the conversation has been terminated is performed such that the communication fee is charged for based on one selected from among the mobile communication terminal of the linked user, the Internet telephone, and the typical telephone, according to a type set in the service application server.

11. The method according to claim 6, further comprising the step of sending a linked user registration request message to the mobile communication terminal when the authentication of the linked user has failed at the step of performing the operation of authenticating the linked user through the service application server.

12. The system according to claim 3, wherein the mobile communication terminal comprises a mobile phone, a Personal Digital Assistant (PDA), a Wibro terminal, a Personal Multimedia Player (PMP) or an electronic dictionary.

13. The method according to claim 8, wherein the mobile communication terminal comprises a mobile phone, a Personal Digital Assistant (PDA), a Wibro terminal, a Personal Multimedia Player (PMP) or an electronic dictionary.

14. The method according to claim 8, wherein the step of conducting conversation between the linked user and the called party through the service application server and then charging the corresponding communication fee for the call after the conversation has been terminated is performed such that the communication fee is charged for based on one selected from among the mobile communication terminal of the linked user, the Internet telephone, and the typical telephone, according to a type set in the service application server.

15. The method according to claim 8, further comprising the step of sending a linked user registration request message to the mobile communication terminal when the authentication of the linked user has failed at the step of performing the operation of authenticating the linked user through the service application server.
